(19) United States
(12) Patent Application Publication
(10) Pub. No.: US 2026/0206074 A1
(43) Pub. Date: Jul. 16, 2026

(54) CONCURRENCY OF FAST CONNECTION AND PERIODIC ADVERTISEMENT (PA)

(71) Applicant: QUALCOMM Incorporated, San Diego, CA (US)

(72) Inventors: Xin WU, Shanghai (CN); Nicolas GRAUBE, Cambridge (GB); Feng CHEN, Shanghai (CN); Jie ZHANG, Shanghai (CN); Robin HEYDON, Cambridge (GB)

(21) Appl. No.: 19/138,064

(22) PCT Filed: Jan. 27, 2023
(86) PCT No.: PCT/CN2023/073483

§ 371 Date: Jun. 11, 2025

(51) Int. Cl. H04W 76/10; H04W 48/08; H04W 84/18

(52) U.S. Cl. CPC H04W 76/10; H04W 48/08; H04W 84/18

(57) ABSTRACT

Disclosed are systems, apparatuses, processes, and computer-readable media for wireless communications. For example, a network device can transmit, to a plurality of wireless communication devices in a period of time, a periodic advertisement comprising a connection operational code. The connection operational code indicates one or more wireless communication devices of the plurality of wireless communication devices and one or more connection times for the one or more wireless communication devices. The network device can transmit, to the plurality of wireless communication devices, one or more connection requests at the one or more connection times. The network device can receive, from the one or more wireless communication devices, one or more connection responses.

### FIELD OF THE DISCLOSURE

The present disclosure generally relates to wireless communications. For example, aspects of the present disclosure relate to concurrency of a fast connection and periodic advertisement (PA).

### BACKGROUND OF THE DISCLOSURE

Short range wireless communication enables wireless communication over relatively short distances (e.g., within thirty meters). For example, BLUETOOTH® is a wireless technology standard for exchanging data over short distances using short-wavelength ultra-high frequency (UHF) radio waves from 2.4 gigahertz (GHz) to 2.485 GHz.

BLUETOOTH® Low Energy (BLE) is a form of BLUETOOTH® communication that allows for communication with devices running on low power. Such devices may include beacons, which are wireless communication devices that may use low-energy communication technology for positioning, proximity marketing, or other purposes. In some cases, such devices may serve as nodes (e.g., relay nodes) of a wireless mesh network that communicates and/or relays information to a managing platform or hub associated with the wireless mesh network.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Systems and techniques are described for wireless communications. According to at least one illustrative example, a network device for wireless communication is provided that includes at least one memory and at least one processor (e.g., implemented in circuitry) coupled to the at least one memory. The at least one processor is configured to: transmit, to a plurality of wireless communication devices in a period of time, a periodic advertisement comprising a connection operational code, the connection operational code indicating one or more wireless communication devices of the plurality of wireless communication devices and one or more connection times for the one or more wireless communication devices; transmit, to the plurality of wireless communication devices, one or more connection requests at the one or more connection times; and receive, from the one or more wireless communication devices, one or more connection responses.

In another illustrative example, a method of wireless communication performed at a network device is provided. The method includes: transmitting, by the network device to a plurality of wireless communication devices in a period of time, a periodic advertisement comprising a connection operational code, the connection operational code indicating one or more wireless communication devices of the plurality of wireless communication devices and one or more connection times for the one or more wireless communication devices; transmitting, by the network device to the plurality of wireless communication devices, one or more connection requests at the one or more connection times; and receiving, by the network device from the one or more wireless communication devices, one or more connection responses.

In another illustrative example, a non-transitory computer-readable medium is provided having stored thereon instructions that, when executed by at least one processor, cause the at least one processor to: transmit, to a plurality of wireless communication devices in a period of time, a periodic advertisement comprising a connection operational code, the connection operational code indicating one or more wireless communication devices of the plurality of wireless communication devices and one or more connection times for the one or more wireless communication devices; transmit, to the plurality of wireless communication devices, one or more connection requests at the one or more connection times; and receive, from the one or more wireless communication devices, one or more connection responses.

In another illustrative example, an apparatus for wireless communication is provided. The apparatus comprises: means for transmitting, to a plurality of wireless communication devices in a period of time, a periodic advertisement comprising a connection operational code, the connection operational code indicating one or more wireless communication devices of the plurality of wireless communication devices and one or more connection times for the one or more wireless communication devices; means for transmitting, to the plurality of wireless communication devices, one or more connection requests at the one or more connection times; and means for receiving, from the one or more wireless communication devices, one or more connection responses.

According to at least one illustrative example, a wireless communication device for wireless communication is provided that includes at least one memory and at least one processor (e.g., implemented in circuitry) coupled to the at least one memory. The at least one processor is configured to: receive, from a network device in a period of time, a periodic advertisement comprising a connection operational code, the connection operational code indicating one or more wireless communication devices of a plurality of wireless communication devices and one or more connection times for the one or more wireless communication devices; receive a connection request at one of the one or more connection times, wherein the wireless communication device is one of the one or more wireless communication devices; and transmit a connection response based on receiving the connection request.

In another illustrative example, a method of wireless communication performed at a wireless communication device is provided. The method includes: receiving, by the wireless communication device of a plurality of wireless communication devices from a network device in a period of time, a periodic advertisement comprising a connection operational code, the connection operational code indicating one or more wireless communication devices of the plurality of wireless communication devices and one or more connection times for the one or more wireless communication devices; receiving, by the wireless communication device, a connection request at one of the one or more connection times, wherein the wireless communication device is one of the one or more wireless communication devices; and transmitting, by the wireless communication device, a connection response based on receiving the connection request.

In another illustrative example, a non-transitory computer-readable medium is provided having stored thereon instructions that, when executed by at least one processor, cause the at least one processor to: receive, from a network device in a period of time, a periodic advertisement comprising a connection operational code, the connection operational code indicating one or more wireless communication devices of a plurality of wireless communication devices and one or more connection times for the one or more wireless communication devices; receive a connection request at one of the one or more connection times, wherein the wireless communication device is one of the one or more wireless communication devices; and transmit a connection response based on receiving the connection request.

In another illustrative example, an apparatus for wireless communication is provided. The apparatus comprises: means for receiving, by the wireless communication device of a plurality of wireless communication devices from a network device in a period of time, a periodic advertisement comprising a connection operational code, the connection operational code indicating one or more wireless communication devices of the plurality of wireless communication devices and one or more connection times for the one or more wireless communication devices; means for receiving, by the wireless communication device, a connection request at one of the one or more connection times, wherein the wireless communication device is one of the one or more wireless communication devices; and means for transmitting, by the wireless communication device, a connection response based on receiving the connection request.

Aspects generally include a method, apparatus, system, computer program product, non-transitory computer-readable medium, user device, user equipment, wireless communication device, and/or processing system as substantially described with reference to and as illustrated by the drawings and specification.

Some aspects include a device having a processor configured to perform one or more operations of any of the methods summarized above. Further aspects include processing devices for use in a device configured with processor-executable instructions to perform operations of any of the methods summarized above. Further aspects include a non-transitory processor-readable storage medium having stored thereon processor-executable instructions configured to cause a processor of a device to perform operations of any of the methods summarized above. Further aspects include a device having means for performing functions of any of the methods summarized above.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims. The foregoing, together with other features and aspects, will become more apparent upon referring to the following specification, claims, and accompanying drawings.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

### BRIEF DESCRIPTION OF THE DRAWINGS

The accompanying drawings are presented to aid in the description of various aspects of the disclosure and are provided solely for illustration of the aspects and not limitation thereof. So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example environment in which systems and/or methods described herein may be implemented, in accordance with some aspects of the present disclosure.

FIG. 2 is a diagram illustrating example components of a device, in accordance with some aspects of the present disclosure.

FIG. 3 is a signaling diagram illustrating example communication transmissions, in accordance with some aspects of the present disclosure.

FIG. 4 is a diagram illustrating example communication transmissions for an example use case, where a fast connection procedure is performed instead of transmission of a periodic advertisement (PA), in accordance with some aspects of the present disclosure.

FIG. 5 is a diagram illustrating example communication transmissions that show the effects of canceling the transmission of a PA, in accordance with some aspects of the present disclosure.

FIG. 6 is a diagram illustrating an example of concurrency of fast connections with a periodic advertisement, where connection transmissions for the fast connections are transmitted within wireless communication device response slots and within another subframe of time, in accordance with some aspects of the present disclosure.

FIG. 7 is a diagram illustrating an example of concurrency of fast connections with a periodic advertisement, where connection transmissions for fast connections are transmitted within wireless communication device response slots within a single subframe of time, in accordance with some aspects of the present disclosure.

FIG. 8 is a flow chart illustrating an example of a process for wireless communications at a network device (e.g., an access point), in accordance with some aspects of the present disclosure.

FIG. 9 is a flow chart illustrating an example of a process for wireless communications at a wireless communication device (e.g., an electronic shelf label), in accordance with some aspects of the present disclosure.

FIG. 10 is a block diagram illustrating an example of a computing system, which may be employed by the disclosed systems and techniques for currency of fast connection and PA, in accordance with some aspects of the present disclosure.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the scope of the application as set forth in the appended claims.

A system may include one or more wireless communication devices that are controlled by a network entity. The network entity may communicate with the one or more wireless communication devices via one or more network devices. For example, an electronic shelf label (ESL) system may include one or more ESLs that are controlled by a management entity (ME). To facilitate control by the management entity, each ESL may have a wireless connection (e.g., a BLUETOOTH® Low Energy (BLE) connection or other connection) to an access point (AP) that is communicatively connected to the management entity (e.g., via the Internet, such as wirelessly, via an Ethernet connection, etc.). In some cases, commands from the management entity may be wirelessly transmitted to the ESLs by the access point. Responses or information from the ESLs may also be received by the access point and provided by the access point to the management entity. Each access point may have an associated channel map. A channel map is a listing of frequency channels to be utilized or, conversely, not to be utilized (e.g., in the context of modification of frequency hopping sequences) by an access point for communication, such as with the ESLs or other devices. While examples are described herein using ESLs as illustrative examples of wireless communication devices, a management entity as an example of a network entity, and access points as examples of network devices, the systems and techniques described herein are applicable to any type of system or network.

In some cases, an ESL may be physically moved to a new location. For example, the ESL may be moved from one location in a retail store (e.g., on a particular shelf or in a storage area) to a different location. Changing the location of the ESL may result in the ESL losing synchronization with (e.g., due to being out of range) a current access point for which the ESL is associated. Such a loss in synchronization may interrupt the management entity's ability to control the ESL and the ESL's ability to report to the management entity. After determining a network outage (e.g., caused by the loss of synchronization), the ESL may perform an onboarding procedure to reestablish synchronization with an access point. To perform the onboarding procedure, the ESL may transmit advertisement messages, receive a connection request (e.g., an auxiliary connection request) from an in-range access point that detected the advertisement messages, and exchange messages with the access point (e.g., including the exchange of periodic advertisement synchronization transfer (PAST) information). The onboarding procedure may consume significant computing resources (e.g., processor resources, memory resources, and/or battery resources, among other examples) of the ESL and/or the access point, and frequent advertisement by one or more ESLs may result in spectral pollution on advertisement channels of the wireless network.

Currently, in the Bluetooth Special Interest Group (SIG) specification, access points can transmit an auxiliary connection request (AUX_CONNECT_REQ) to ESLs instead of transmitting a periodic advertisement including a synchronization packet. A standard auxiliary connection request (AUX_CONNECT_REQ) allows for only one ESL within a subframe of time of ESLs to be triggered by an access point to setup a connection with that access point. A periodic advertisement can include eleven (11) operational codes (OpCodes), where each OpCode is addressing one of the eleven ESLs within the subframe of time. However, when the transmission of the periodic advertisement is canceled for the transmission of an auxiliary connection request, various different detrimental side effects can occur.

For example, one detrimental side effect that can occur without the transmission of the periodic advertisement is that an ESL response packet (ERP) can be delayed at least 1.6 seconds (e.g., the frame of time for the ESL group, which is equal to 12.5 milliseconds per subframe*128 groups of ESLs, with each group of ESLs corresponding to one subframe). This delay of the ESL response packet can deleteriously impact the mean response time (MRT) of the OpCode.

Another detrimental side effect that can occur is when, in some cases, the canceled periodic advertisement is the sixth consecutive loss of periodic advertisement to some of the ESLs within the group of ESLs. When an ESL does not receive a periodic advertisement after six tries, an ESL is assumed to be out of synchronization with its associated access point. As such, this sixth consecutive loss of periodic advertisement to some of the ESLs can lead to these ESLs becoming out of synchronization with the access point and, as such, requiring these ESLs to perform an onboarding procedure. In some cases, ESLs may remain synchronized with the access point if an auxiliary connection request is received by the ESLs.

In another example, another detrimental side effect that can occur without the transmission of the periodic advertisement is that other functions and/or features associated with information within the periodic advertisement may be negatively impacted. For example, a keepalive OpCode (e.g., instructing a specific ESL to remain alive and in synchronization with the access point), which may be contained within the information of the periodic advertisement, may not be received by an ESL and, as such, that ESL may become out of synchronization and need to perform an onboarding procedure.

As such, the ability to transmit an auxiliary connection request along with a periodic advertisement within the same subframe of time should improve the system performance.

Systems and techniques are described herein for providing concurrency of a fast connection (e.g., an auxiliary connection between an access point and an ESL) and a periodic advertisement. For example, the systems and techniques can provide solutions for an access point to be able to transmit an auxiliary connection request and a periodic advertisement within the same subframe of time. In particular, the systems and techniques can create a new vendor specific operational code (VSOpCode) within a periodic advertisement to notify specific ESLs to listen for (to receive) an auxiliary connection request at a designated future time. In one or more examples, the VSOpCode may include information including, but not limited to, an ESL identification (e.g., the identification of the ESL within the subframe of time that the access point wants to connect with), a channel index (e.g., the channel index of the access point for the ESL to connect with), and a time offset (e.g., which specifies a specific future time for the ESL to listen for the auxiliary connection request).

In one or more aspects, the systems and techniques make concurrency of the periodic advertisement function and the auxiliary connection request/response function such as to mitigate any issues that may be caused by not transmitting the periodic advertisement. In one or more aspects, the systems and techniques employ a periodic advertisement that includes this new VSOpCode. This periodic advertisement, which includes this new VSOpCode, can trigger up to three (3) BLE connections within the same subframe of time in a single access point use scenario, and can trigger up to 3*N number of BLE connections within the same subframe of time in a multi-access point use scenario, where N is the number of access points.

Additional aspects of the present disclosure are described in more detail below.

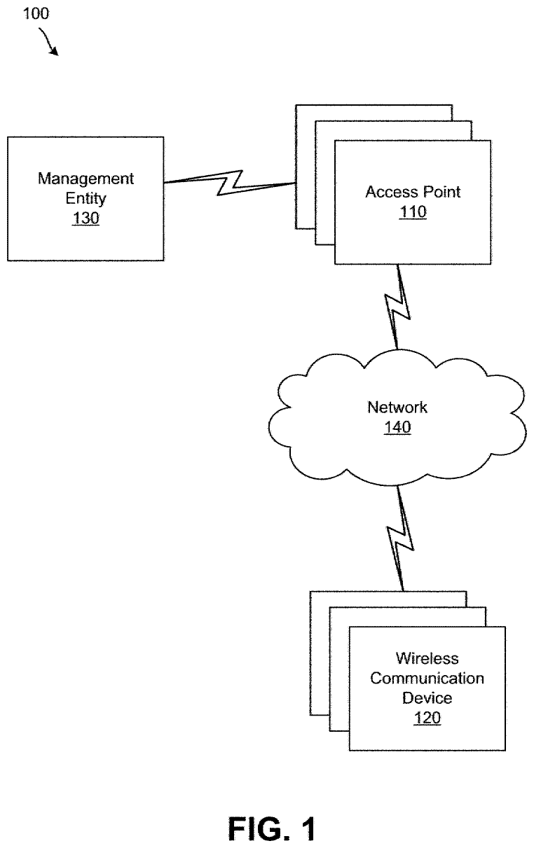

FIG. 1 is a diagram of an example environment 100 in which systems and/or methods described herein may be implemented. As shown in FIG. 1, the environment 100 may include at least one access point (AP) 110, at least one wireless communication device 120, a management entity (ME) 130, and a network 140. Devices of the environment 100 may interconnect via wired connections, wireless connections, or a combination of wired and wireless connections.

The access point 110 may include one or more devices capable receiving, generating, storing, processing, providing, and/or routing information associated with access point synchronization and/or handover, as described elsewhere herein. The access point 110 may include a communication device and/or a computing device. The access point 110 may be configured to transmit beacons (e.g., BLE beacons), as well as to scan and locate other devices (e.g., other devices communicating using BLE protocols).

The wireless communication device 120 may include one or more devices capable of receiving, generating, storing, processing, and/or providing information associated with access point synchronization and/or handover, as described elsewhere herein. The wireless communication device 120 may include a communication device and/or a computing device. In some aspects, the wireless communication device 120 may be, may include, or may be included in an electronic shelf label (ESL).

The management entity 130 includes one or more devices capable of receiving, generating, storing, processing, providing, and/or routing information associated with access point synchronization and/or handover, as described elsewhere herein. The management entity 130 may include a communication device and/or a computing device. For example, the management entity 130 may include a server, such as an application server, a client server, a web server, a database server, a host server, a proxy server, a virtual server (e.g., executing on computing hardware), or a server in a cloud computing system. In some aspects, the management entity 130 includes computing hardware used in a cloud computing environment. The management entity 130 may provide control of a system (e.g., an ESL system) that includes the access point(s) 110, the wireless communication device(s) 120, and/or the device(s) 130. The access point(s) 110 may be communicatively connected to the management entity 130 via a network (not shown), such as the Internet.

The network 140 may include one or more wireless networks. For example, the network 140 may include a personal area network (e.g., a Bluetooth network). The network 140 enables communication among the devices of environment 100.

The number and arrangement of devices and networks shown in FIG. 1 are provided as an example. In practice, there may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) of environment 100 may perform one or more functions described as being performed by another set of devices of environment 100.

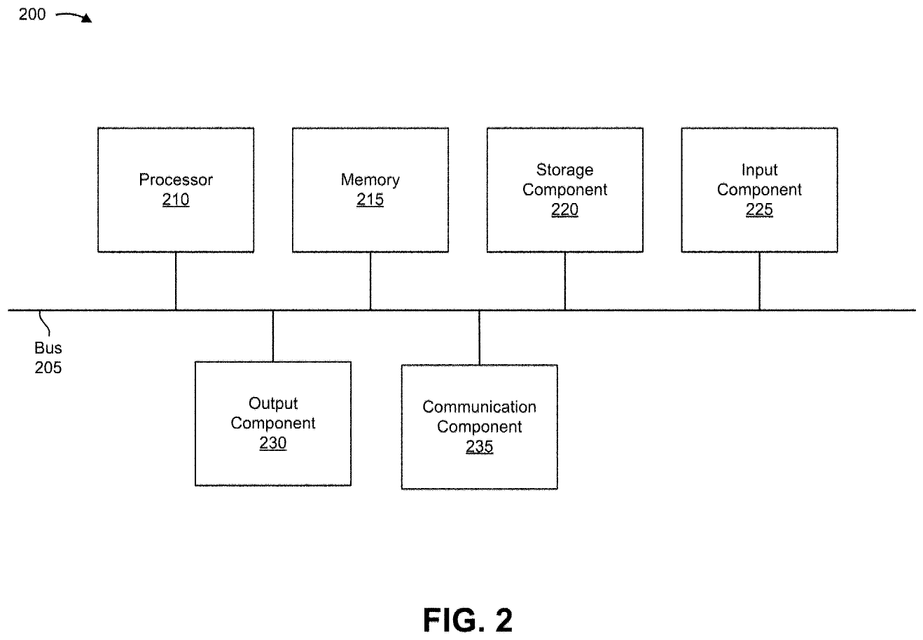

FIG. 2 is a diagram illustrating example components of a device 200, in accordance with the present disclosure. Device 200 may correspond to access point 110, wireless communication device 120, and/or management entity 130. In some aspects, access point 110, wireless communication device 120, and/or management entity 130 may include one or more devices 200 and/or one or more components of device 200. As shown in FIG. 2, device 200 may include a bus 205, a processor 210, a memory 215, a storage component 220, an input component 225, an output component 230, and/or a communication component 235.

Bus 205 may include a component that permits communication among the components of device 200. Processor 210 may be implemented in hardware, firmware, or a combination of hardware and software. Processor 210 may be a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some aspects, processor 210 may include one or more processors capable of being programmed to perform a function. Memory 215 may include a random access memory (RAM), a read only memory (ROM), and/or another type of dynamic or static storage device (e.g., a flash memory, a magnetic memory, and/or an optical memory) that stores information and/or instructions for use by processor 210.

Storage component 220 can store information and/or software related to the operation and use of device 200. For example, storage component 220 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

Input component 225 may include a component that permits device 200 to receive information, such as via user input (e.g., a touch screen display, a keyboard, a keypad, a mouse, a button, a switch, and/or a microphone). Additionally, or alternatively, input component 225 may include a component for determining a position or a location of device 200 (e.g., a global positioning system (GPS) component or a global navigation satellite system (GNSS) component) and/or a sensor for sensing information (e.g., an accelerometer, a gyroscope, an actuator, or another type of position or environment sensor). Output component 230 can include a component that provides output information from device 200 (e.g., a display, a speaker, a haptic feedback component, and/or an audio or visual indicator).

Communication component 235 may include one or more transceiver-like components (e.g., a transceiver and/or a separate receiver and transmitter) that enables device 200 to communicate with other devices, such as via a wired connection, a wireless connection, or a combination of wired and wireless connections. Communication component 235 may permit device 200 to receive information from another device and/or provide information to another device. For example, communication component 235 may include an Ethernet interface, an optical interface, a coaxial interface, an infrared interface, a radio frequency interface, a universal serial bus (USB) interface, a wireless local area interface (e.g., a Wi-Fi interface or a BLE interface), and/or a cellular network interface.

Communication component 235 may include one or more antennas for receiving wireless radio frequency (RF) signals transmitted from one or more other devices, cloud networks, and/or the like. The antenna may be a single antenna or an antenna array (e.g., antenna phased array) that can facilitate simultaneous transmit and receive functionality. The antenna may be an omnidirectional antenna such that signals can be received from and transmitted in all directions. The wireless signals may be transmitted via a wireless network. The wireless network may be any wireless network, such as a cellular or telecommunications network (e.g., 3G, 4G, 5G, etc.), wireless local area network (e.g., a WiFi network), a Bluetooth™ network, and/or other network.

The one or more transceiver-like components (e.g., a wireless transceiver) of the communication component 235 may include an RF front end including one or more components, such as an amplifier, a mixer (also referred to as a signal multiplier) for signal down conversion, a frequency synthesizer (also referred to as an oscillator) that provides signals to the mixer, a baseband filter, an analog-to-digital converter (ADC), one or more power amplifiers, among other components. The RF front-end can generally handle selection and conversion of the wireless signals into a baseband or intermediate frequency and can convert the RF signals to the digital domain.

In some cases, a CODEC may be implemented (e.g., by the processor 210) to encode and/or decode data transmitted and/or received using the one or more wireless transceivers. In some cases, encryption-decryption may be implemented (e.g., by the processor 210) to encrypt and/or decrypt data (e.g., according to the Advanced Encryption Standard (AES) and/or Data Encryption Standard (DES) standard) transmitted and/or received by the one or more wireless transceivers.

In some aspects, device 200 may represent an ESL. The ESL may include a battery in addition to the aforementioned components. In some aspects, the output component 230 of the ESL may be an electronic paper (e-paper) display or a liquid crystal display (LCD).

Device 200 may perform one or more processes described herein. Device 200 may perform these processes based on processor 210 executing software instructions stored by a non-transitory computer-readable medium, such as memory 215 and/or storage component 220. A computer-readable medium is defined herein as a non-transitory memory device. A memory device includes memory space within a single physical storage device or memory space spread across multiple physical storage devices.

Software instructions may be read into memory 215 and/or storage component 220 from another computer-readable medium or from another device via communication component 235. When executed, software instructions stored in memory 215 and/or storage component 220 may cause processor 210 to perform one or more processes described herein. Additionally, or alternatively, hardwired circuitry may be used in place of or in combination with software instructions to perform one or more processes described herein. Thus, aspects described herein are not limited to any specific combination of hardware circuitry and software.

The number and arrangement of components shown in FIG. 2 are provided as an example. In practice, device 200 may include additional components, fewer components, different components, or differently arranged components than those shown in FIG. 2. Additionally, or alternatively, a set of components (e.g., one or more components) of device 200 may perform one or more functions described as being performed by another set of components of device 200.

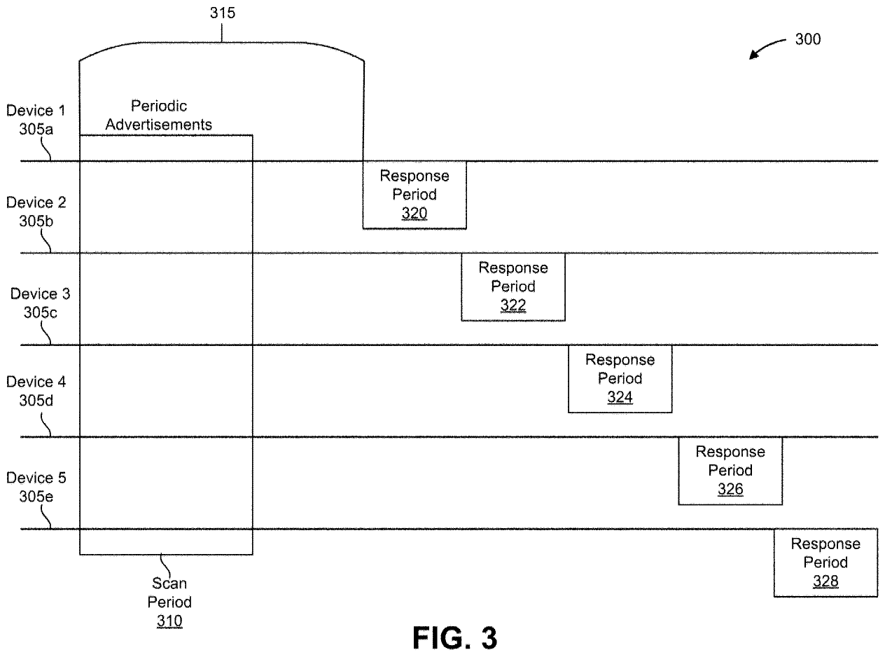

FIG. 3 is a signal timing diagram illustrating a portion of a communication between an access point (e.g., access point 110) and wireless communication devices 120 (e.g., ESLs). With reference to FIG. 1, the signal sequence illustrated in FIG. 3 may be implemented by one or more of the communication connections, access points 110, and/or wireless communication devices 120 of FIG. 1.

The devices (e.g., device 1 305a, device 2 305b, device 3 305c, device 4 305d, and device 5 305e) of FIG. 3 may be selected from wireless communication devices 120 of FIG. 1, and may each receive a periodic advertisement (PA) in a scan period 310. The scan period 310 may occur in regularly scheduled intervals and may be repeated periodically such that the devices (e.g., device 1 305a, device 2 305b, device 3 305c, device 4 305d, and device 5 305e) can awaken to scan for messages during this repeated scan period 310. An access point (e.g., access point 110 of FIG. 1) may provide periodic advertisements (PAS) via broadcast or multi-cast to the devices (e.g., device 1 305a, device 2 305b, device 3 305c, device 4 305d, and device 5 305e) in the scan period 310. For an access point (e.g., access point 110 of FIG. 1), the scan period 310 can be its primary transmission period. In some cases, the scan period 310 may not be a fixed time because the access point (e.g., access point 110 of FIG. 1) may send different lengths of data from the start of the scan period 310.

The transmission may include multiple advertisements in a train. One or more portions of the advertisements may be directed to one or more of the devices (e.g., device 1 305a, device 2 305b, device 3 305c, device 4 305d, and device 5 305e). The devices (e.g., device 1 305a, device 2 305b, device 3 305c, device 4 305d, and device 5 305e) may decode or filter the messages intended for each specific device and transmitted during the period when all devices are receiving. In this way, the devices (e.g., device 1 305a, device 2 305b, device 3 305c, device 4 305d, and device 5 305e) may be reprogrammed, updated, and/or sent requests from an access point (e.g., access point 110 of FIG. 1) or relayed from another device (e.g., management entity 130 of FIG. 1) through the access point (e.g., access point 110 of FIG. 1). The periodic advertisement (PA) from the access point (e.g., access point 110 of FIG. 1) may set a response period for one or more of the devices (e.g., device 1 305a, device 2 305b, device 3 305c, device 4 305d, and device 5 305e).

As illustrated, the devices (e.g., device 1 305a, device 2 305b, device 3 305c, device 4 305d, and device 5 305e) are each assigned a response period 320, 322, 324, 326, 328 in the time after the scan period 310. The first response period 320 may begin following an idle time 315 after the scan period 310, with the idle period being long enough to provide the transmitter device an opportunity to do other Bluetooth related activities. The assigned response periods may also be limited to or designate a particular frequency of the channels on which to respond. For example, in FIG. 3, device 1 305a is assigned response period 320, device 2 305b is assigned response period 322, device 3 305c is assigned response period 324, device 4 305d is assigned response period 326, and device 5 305e is assigned response period 328. The access point (e.g., access point 110 of FIG. 1) may store attributes of the devices (e.g., device 1 305a, device 2 305b, device 3 305c, device 4 305d, and device 5 305e), including whether a device is able to transmit or respond. The PA signaling followed by responses can be referred to as periodic advertisement with multiple responses (PAwMR).

For example, device 3 305c (e.g., wireless communication device 120 of FIG. 1) may be an ESL and may receive a price update in a PA from the access point (e.g., access point 110 of FIG. 1) in scan period 310. The PA received at device 3 305c may include a designated start time for the response period 324 or may include a schedule of response start times for devices including device 3 305c. The response by device 3 305c to the access point (e.g., access point 110 of FIG. 1) may include an acknowledgement, a status code, and/or other information such as battery life, received signal strength, and/or an error notification. The response by device 3 305c may include information to be relayed to another device by the access point (e.g., access point 110 of FIG. 1). The response may include a packet with a header and may conform to any of the Bluetooth protocols. A response may be transmitted in a data channel of the Bluetooth protocol to the access point (e.g., access point 110 of FIG. 1). Both the PA and the responses from all of the devices (e.g., device 1 305a, device 2 305b, device 3 305c, device 4 305d, and device 5 305e) may use channels of the Bluetooth protocol.

A device (e.g., device 5 305e) that has been assigned a response period may not respond and may determine that it has nothing to signal. In other words, the devices (e.g., device 1 305a, device 2 305b, device 3 305c, device 4 305d, and device 5 305e) may determine what response, if any, is required and may or may not respond to a request sent from the access point (e.g., access point 110 of FIG. 1). The response periods 320, 322, 324, 326, 328 may be assigned based on a request for such a period in an open transmission time, the request being sent to the access point (e.g., access point 110 of FIG. 1). The response periods 320, 322, 324, 326, 328 may be assigned based on which devices have been requested by the access point (e.g., access point 110 of FIG. 1) to send data or acknowledgements. The PA messages and responses may be frequency-hopped, time synchronized channels, and/or extended channels of the advertising channels in Bluetooth.

As previously mentioned, in the Bluetooth SIG specification, currently, access points can transmit an auxiliary connection request (AUX_CONNECT_REQ) to one or more ESLs (e.g., a specific ESL in a group of ESLs) instead of transmitting a periodic advertisement (PA) including a synchronization (sync) packet. For example, an example of a standard auxiliary connection request (AUX_CONNECT_REQ) allows for only one ESL within a subframe of ESLs (e.g., a group of ESLs associated with the subframe) to be triggered by an access point to setup a connection with that access point. A periodic advertisement can include eleven (11) operational codes (OpCodes), where each OpCode is addresses one of the eleven ESLs within the subframe of time of a frame of time.

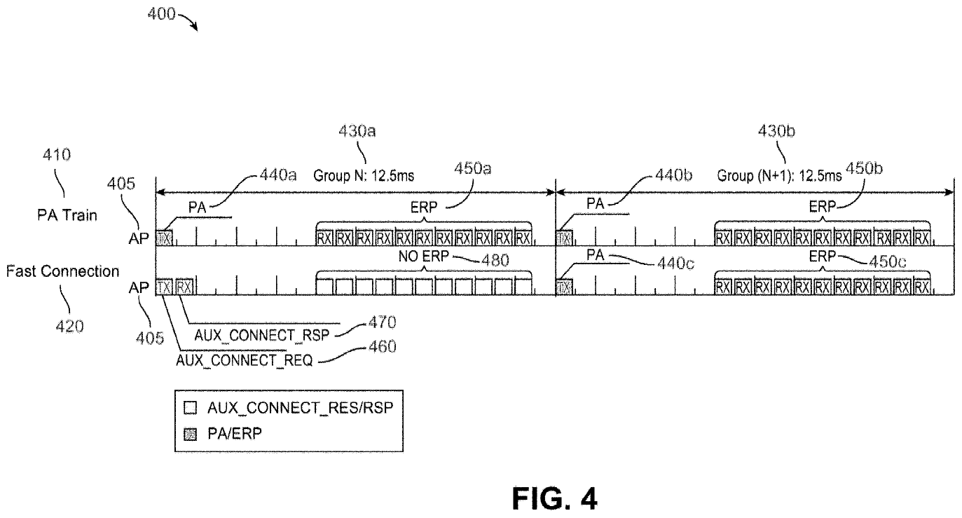

FIG. 4 shows an example use case where an access point 405 is transmitting an auxiliary connection request (AUX_CONNECT_REQ) 460 to ESLs (e.g., wireless communication devices 120 of FIG. 1 in the form of ESLs) instead of transmitting a periodic advertisement (PA) 440a including a synchronization (sync) packet to the ESLs. In particular, FIG. 4 is a diagram illustrating example communication transmissions 400 for an example use case, where a fast connection procedure is performed instead of transmission of a periodic advertisement (PA) 440a. A fast connection procedure can include the transmission by an access point 405 (e.g., access point 110 of FIG. 1) of an auxiliary connection request (AUX_CONNECT_REQ) 460 to ESLs (e.g., all ESLs within a group of ESLs receive the auxiliary connection request) and the receiving by that access point 405 of an auxiliary connection response (AUX_CONNECT_RSP) 470 from one or more of the ESLs (e.g., only one ESL within the group of ESLs that received the auxiliary connection request).

In FIG. 4, two subframes 430a, 430b of time of a frame of time are shown. For each subframe 430a, 430b of time, the access point 405 can transmit communication transmissions (e.g., periodic advertisements, such as PAs 440a, 440b, 440c, and auxiliary connection requests, such as AUX_CONNECT_REQ 460) to a respective set of eleven ESLs. For example, for subframe 430a of time, the access point 405 may transmit communications transmissions to a first set of ESLs (e.g., ESL1 to ESL 11 of a group of up to 255 ESLs); and for subframe 430b of time, the access point 405 may transmit communication transmissions to a second set of ESLs (e.g., ESL 12 to ESL 22 of the group of up to 255 ESLs). In one or more examples, each subframe 430a, 430b of time may be 12.5 milliseconds.

In FIG. 4, the upper portion of the figure shows the transmission of a PA train 410 by the access point 405, and the lower portion of the figure shows a fast connection 420. For the PA train 410 in FIG. 4, in the first subframe 430a of time, during operation, the access point 405 can transmit (e.g., broadcast) a PA 440a to the first set of ESLs (e.g., ESL 1 to ESL 11). The PA 440a can include a synchronization (sync) packet with eleven OpCodes. Each of the eleven OpCodes is associated with a respective ESL of the first set of eleven ESLs. The eleven OpCodes specify a time slot for their associated ESL to transmit a response (e.g., an ESL response packet (ERP)) to the access point 405. After the ESLs (e.g., ESL 1 to ESL 11) receive the PA 440a from the access point 405, the ESLs (e.g., ESL 1 to ESL 11) can transmit (in response to receiving the PA 440a) ERPs 450a in their respective time slots. Then, the access point 405 can receive the ERPs 450a in those time slots.

For the PA train 410 in FIG. 4, in the second subframe 430a of time, during operation, the access point 405 can transmit (e.g., broadcast) a PA 440b to the second set of ESLs (e.g., ESL 12 to ESL 22). The PA 440b can include a synchronization (sync) packet with eleven OpCodes, which are each associated with a respect ESL of the second set of eleven ESLs. The eleven OpCodes specify a time slot for their associated ESL to transmit a response (e.g., an ERP) to the access point 405. After the ESLs (e.g., ESL 12 to ESL 22) receive the PA 440b from the access point 405, the ESLs (e.g., ESL 12 to ESL 22) can transmit (in response to receiving the PA 440b) ERPs 450b in their respective time slots. Then, the access point 405 can receive the ERPs 450b in those time slots.

For the fast connection 420 in FIG. 4, in the first subframe 430a of time, during operation, the access point 405 can transmit (e.g., broadcast) an auxiliary connection request (AUX_CONNECT_REQ) 460, instead of a periodic advertisement, to the first set of ESLs (e.g., ESL 1 to ESL 11). The AUX_CONNECT_REQ 460 is a request from the access point 405 to a specific ESL (e.g., ESL 1) of the first set of ESLs (e.g., ESL 1 to ESL 11) to connect with the access point 405. After the ESLs (e.g., ESL 1 to ESL 11) receive the AUX_CONNECT_REQ 460 from the access point 405, the ESL (e.g., ESL 1) addressed in the AUX_CONNECT_REQ 460 can transmit an auxiliary connection response (AUX_CONNECT_RSP) 470 to the access point 405 to acknowledge the receipt of the connection request. The access point 405 can receive the AUX_CONNECT_RSP 470. After the access point 405 receives the AUX CONNECT RSP 470 from the ESL (e.g., ESL 1), the access point 405 can transmit a data packet to the ESL (e.g., ESL 1) to establish a connection with the ESL (e.g., ESL 1). After the ESL (e.g., ESL 1) receives the data packet from the access point 405, the connection between the access point 405 and the ESL (e.g., ESL 1) is established.

For the fast connection 420 in FIG. 4, in the second subframe 430b of time, during operation, the access point 405 can transmit (e.g., broadcast) a PA 440c to the second set of ESLs (e.g., ESL 12 to ESL 22). The PA 440c can include a synchronization (sync) packet with eleven OpCodes, which may each be associated with a respect ESL of the second set of eleven ESLs. The eleven OpCodes can specify a time slot for their associated ESL to transmit a response (e.g., an ERP) to the access point 405. After the ESLs (e.g., ESL 12 to ESL 22) receive the PA 440c from the access point 405, the ESLs (e.g., ESL 12 to ESL 22) can transmit (in response to receiving the PA 440c) ERPs 450c in their respective time slots. Then, the access point 405 can receive the ERPs 450c in the time slots.

In one or more examples, when the transmission of the periodic advertisement (PA) is canceled for the transmission of an auxiliary connection request (AUX_CONNECT_REQ), various different disadvantageous side effects can occur. For example, one disadvantageous side effect that can occur without the transmission of the periodic advertisement is that an ERP can be delayed at least 1.6 seconds (e.g., the frame of time for the ESL group, which is equal to 12.5 milliseconds per subframe*128 groups of ESLs). This delay of the ERP can deleteriously impact the mean response time (MRT) of the OpCode.

Another disadvantageous side effect that can occur is when, in some cases, the canceled periodic advertisement is the sixth consecutive loss of periodic advertisement to some of the ESLs within the group of ESLs. When an ESL does not receive a periodic advertisement after six tries, an ESL can be assumed to be out of synchronization with its associated access point. As such, this sixth consecutive loss of periodic advertisement to some of the ESLs can result in these ESLs becoming out of synchronization with the access point and, as such, can require these ESLs to perform an onboarding procedure. In some cases, ESLs may remain synchronized with the access point if an auxiliary connection request is received by the ESLs.

In another example, another disadvantageous side effect that can occur without the transmission of the periodic advertisement is that other functions and/or features associated with information within the periodic advertisement can be negatively impacted. For example, a keepalive OpCode (e.g., which can instruct a specific ESL to remain alive and in synchronization with the access point), which can be contained within the information of the periodic advertisement, may not be received by an ESL and, as such, that ESL may become out of synchronization and need to perform an onboarding procedure.

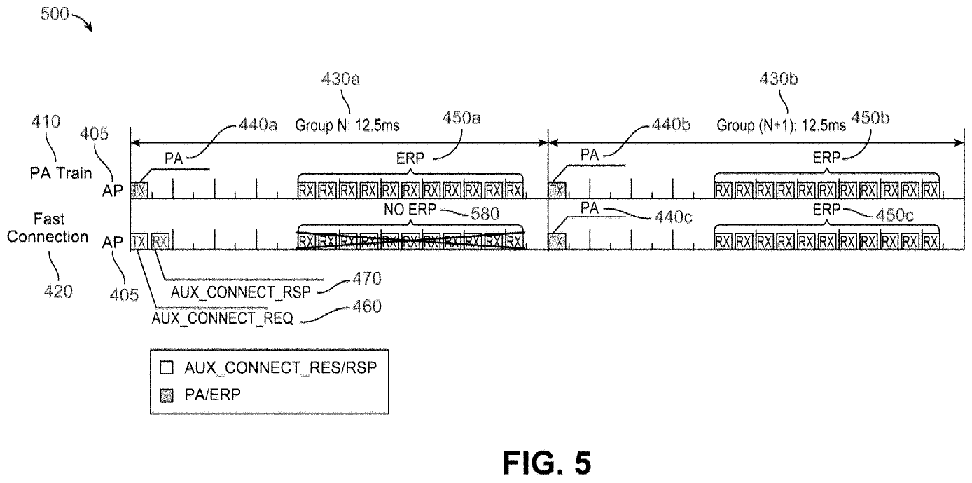

FIG. 5 is a diagram illustrating example communication transmissions 500 that show the effects of canceling the transmission of a periodic advertisement (e.g., PA 440a). FIG. 5 is similar to FIG. 4, except that in FIG. 5, the ERPs 580 are shown to be crossed-out. The crossing-out of the ERPs 580 indicates that since an auxiliary connection request (AUX_CONNECT_REQ) is being transmitted by the access point 405 instead of a periodic advertisement (e.g., PA 440a), the access point 405 will not receive any ERPs 580 from the ESLs (e.g., ESL 1 to ESL 11). The access point 405 will not receive any ERPs 580 because the ESLs (e.g., ESL 1 to ESL 11) will not receive a periodic advertisement (e.g., PA 440a) and, as such, the ESLs (e.g., ESL 1 to ESL 11) will not transmit ERPs, 580 which are transmitted to acknowledge receipt of a periodic advertisement.

In one or more aspects, the systems and techniques provide concurrency of a fast connection (e.g., an auxiliary connection between an access point and an ESL) and a periodic advertisement. In particular, the systems and techniques provide solutions for an access point to have the ability to transmit an auxiliary connection request (AUX_CONNECT_REQ) and a periodic advertisement within the same subframe of time.

In one or more examples, the systems and techniques can create a new vendor specific operational code (VSOpCode), which may be referred to as a connection operational code, within a periodic advertisement to notify specific ESLs to listen for (to receive) an auxiliary connection request at a designated future time. In one or more examples, the VSOpCode may include information including, but not limited to, an ESL identification (Eid) (e.g., the identification of the ESL within the subframe of time that the access point wants to connect with), a channel index (e.g., the channel index for the hopping frequency sequence (HFS) of the access point for the ESL to connect with), and a time offset (e.g., which specifies a specific future time for the ESL to listen for the auxiliary connection request). In one or more examples, the specific future time (e.g., which may be referred to as a connection time) specified by the time offset may be equal to a time at the beginning of the subframe plus the time offset (e.g., time_offset) within the VSOpCode.

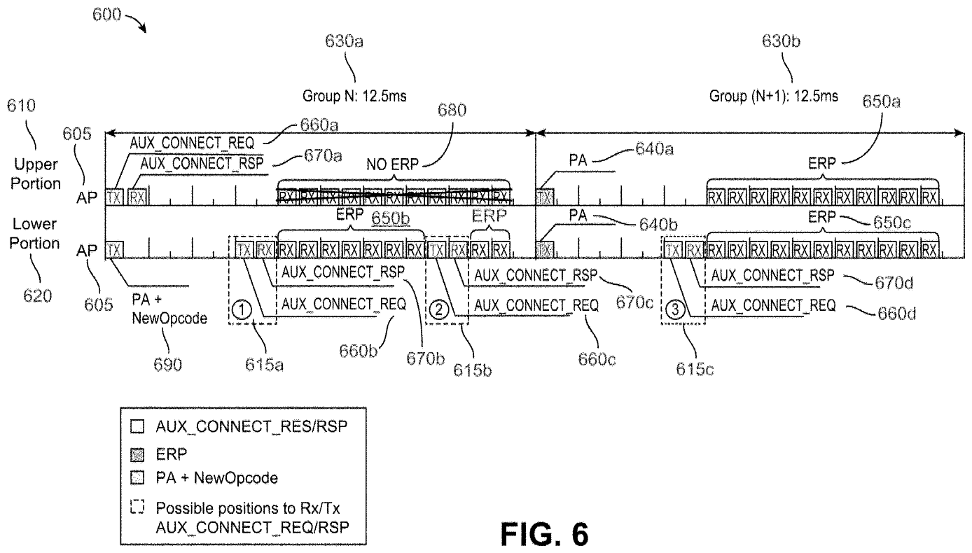

FIG. 6 shows an example of connection transmissions 600 that include the transmission of a periodic advertisement with the VSOpCode (e.g., PA+NewOpCode 690). In particular, FIG. 6 is a diagram illustrating an example of concurrency of fast connections 615a, 615b, 615c with a periodic advertisement (e.g., PA+NewOpCode 690), where connection transmissions 600 for the fast connections 615a, 615b, 615c are transmitted within wireless communication device (e.g., ESL) response slots (e.g., a periodic advertisement response period, such as ERP 650b response slots) and within another subframe (e.g., subframe 630b) of time. Fast connections 615a, 615b, 615c can include the transmission by an access point 605 (e.g., a network device, such as access point 110 of FIG. 1) of an auxiliary connection requests (AUX_CONNECT_REQ) 660a, 660b, 660c, 660d (e.g., which may each be referred to as a connection request) to ESLs, and the receiving by that access point 605 of auxiliary connection responses (AUX_CONNECT_RSP) 670a, 670b, 670c, 670d (e.g., which may each be referred to as a connection response) from the ESLs.

In one or more examples, fast connections may be located within any vacant time slot within the same subframe (e.g., a period of time). For example, a fast connection (e.g., fast connection 615a) may be located in any vacant time slot within the same subframe, as long as the ESL has the capability of getting ready to receive at the 4.5 milliseconds time offset of the beginning of the subframe 630a. For another example, a fast connection (e.g., fast connection 615b) may be located within any two neighboring ERP slots (e.g., of the eleven ERP 650b slots) as long as no OpCode uses it for a response. In one or more examples, fast connections (e.g., fast connection 615c) may be located within any vacant time slot in a subsequent subframe (e.g., a period of time, such as subframe 630b, that is subsequent to a period of time, such as subframe 630a). This possible location for a fast connection may not follow the current rule that an ESL in one subframe can only handle an ERP within its own subframe. However, this possible location for a fast connection may be implemented as a future enhancement of periodic advertisements with response (PAR).

FIG. 6 shows two subframes 630a, 630b of time of a frame of time. For each subframe 630a, 630b of time, the access point 605 may transmit communication transmissions (e.g., periodic advertisements and auxiliary connection requests) to a respective set of eleven ESLs (e.g., wireless communication devices). In one or more examples, for subframe 630a of time, the access point 605 can transmit communications transmissions to a first set of ESLs (e.g., ESL 1 to ESL 11 of a group of up to 255 ESLs); and for subframe 630b of time, the access point 605 can transmit communication transmissions to a second set of ESLs (e.g., ESL 12 to ESL 22 of the group of up to 255 ESLs). Each subframe 630a, 630b of time can have duration of time of 12.5 milliseconds.

In FIG. 6, the upper portion 610 of the figure shows the transmission of an auxiliary connection request instead of a periodic advertisement (e.g., which may have detrimental side effects), and the lower portion 620 of the figure shows the transmission of a periodic advertisement with the VSOpCode for fast connections. For the upper portion 610 of FIG. 6, in the first subframe 630a of time, during operation, the access point 605 can transmit (e.g., broadcast) an auxiliary connection request (AUX_CONNECT_REQ) 660a, instead of a periodic advertisement, to the first set of ESLs (e.g., ESL 1 to ESL 11). The AUX_CONNECT_REQ 660a is a request from the access point 605 to a specific ESL (e.g., ESL 1) of the first set of ESLs (e.g., ESL 1 to ESL 11) to connect with the access point 605. After the ESLs (e.g., ESL 1 to ESL 11) receive the AUX_CONNECT_REQ 660a from the access point 605, the ESL (e.g., ESL 1) addressed in the AUX_CONNECT_REQ 660a may transmit an auxiliary connection response (AUX_CONNECT_RSP) 670a to the access point 605 to acknowledge the receipt of the connection request. The access point 605 can then receive the AUX_CONNECT RSP 670a. After the access point 605 receives the AUX CONNECT RSP 670a from the ESL (e.g., ESL 1), the access point 605 may transmit a data packet to the ESL (e.g., ESL 1) to establish a connection with the ESL (e.g., ESL 1). After the ESL (e.g., ESL 1) receives the data packet from the access point 605, the connection between the access point 605 and the ESL (e.g., ESL 1) is established.

Since the access point 605 has transmitted (e.g., broadcasted) an auxiliary connection request (AUX_CONNECT_REQ) 660a, instead of a periodic advertisement, to the first set of ESLs (e.g., ESL 1 to ESL 11), the access point 605 will not receive any ERPs 680 because the ESLs (e.g., ESL 1 to ESL 11) will not receive a periodic advertisement (e.g., PA) and, as such, the ESLs (e.g., ESL 1 to ESL 11) will not transmit ERPs 680, which are transmitted to acknowledge receipt of a periodic advertisement.

For the upper portion 610 of FIG. 6, in the second subframe 630b of time, during operation, the access point 605 can transmit (e.g., broadcast) a PA 640a to the second set of ESLs (e.g., ESL 12 to ESL 22). The PA 640a may include a synchronization (sync) packet with eleven OpCodes, which are each associated with a respect ESL of the second set of eleven ESLs. The eleven OpCodes can specify a time slot for their associated ESL to transmit a response (e.g., an ERP) to the access point 605. After the ESLs (e.g., ESL 12 to ESL 22) receive the PA 640a from the access point 605, the ESLs (e.g., ESL 12 to ESL 22) can transmit (in response to receiving the PA 640a) ERPs 650a in their respective time slots. Then, the access point 605 may receive the ERPs 650a in those time slots.

For the lower portion 620 of FIG. 6, in the first subframe 630a of time, during operation, the access point 605 can transmit (e.g., broadcast) a periodic advertisement with the VSOpCode (e.g., PA+NewOpCode 690) to the first set of ESLs (e.g., ESL 1 to ESL 11). The VSOpCode may include at least one ESL identification (Eid) (e.g., the identification of an ESL within the subframe of time that the access point wants to connect with), at least one channel index (e.g., the channel index for the hopping frequency sequence (HFS) of the access point for an ESL to connect with), and at least one time offset (e.g., which specifies a specific future time for an ESL to listen for an auxiliary connection request).

For example, the VSOpCode may include the Eids for ESL 1, ESL 2, and ESL 3; a channel index for the access point 605; and time offsets for ESL 1, ESL 2, and ESL 3. For this example, the time offset for ESL 1 may specify that ESL 1 should listen for the AUX CONNECT_REQ 660b from access point 605 in the time slots just prior to the beginning of the ERP 650b response slots of the first subframe 630a of time, the time offset for ESL 2 may specify that ESL 2 should listen for the AUX_CONNECT_REQ 660c from the access point 605 in time slots that are within the ERP 650b response slots of the first subframe 630a of time, and the time offset for ESL 3 may specify that ESL 3 should listen for the AUX_CONNECT_REQ 660d from the access point 605 in time slots that are just prior to the beginning of the ERP 650c response slots of the second subframe 630b of time.

After the ESLs (e.g., ESL 3 to ESL 11) receive the periodic advertisement with the VSOpCode (e.g., PA+NewOpCode 690) from the access point 605, the ESLs (e.g., ESL 3 to ESL 11) can transmit (in response to receiving the PA+NewOpCode 690) ERPs 650b in their respective time slots. The access point 605 can receive the ERPs 650b in those time slots.

After ESL 1, ESL 2, and ESL 3 receive the periodic advertisement with the VSOpCode (e.g., PA+NewOpcode 690), ESL 1, ESL 2, and ESL 3 can ensure that they are tuned to the HFS associated with the channel index for the access point 605 as indicated in the VSOpCode. ESL 1 can listen at the specified future time for the AUX CONNECT REQ 660b from the access point 605, ESL 2 can listen at the specified future time for the AUX_CONNECT_REQ 660c from the access point 605, and ESL 3 can listen at the specified future time for the AUX_CONNECT_REQ 660d from the access point 605.

After ESL 1 has received the AUX_CONNECT_REQ 660b, ESL 1 can transmit an AUX CONNECT_RSP 670b to acknowledge receipt of the connection request. After ESL 2 has received the AUX CONNECT_REQ 660c, ESL 2 can transmit an AUX CONNECT RSP 670c to acknowledge receipt of the connection request. Similarly, after ESL 3 has received the AUX_CONNECT_REQ 660d, ESL 3 can transmit an AUX CONNECT RSP 670d to acknowledge receipt of the connection request.

After the access point 605 receives the AUX_CONNECT RSP 670b from ESL 1, the access point 605 can transmit a data packet to ESL 1 to establish a connection with ESL 1. After the ESL 1 receives the data packet from the access point 605, the connection between the access point 605 and the ESL 1 is established. After the access point 605 receives the AUX CONNECT RSP 670c from ESL 2, the access point 605 can transmit a data packet to ESL 2 to establish a connection with ESL 2. After the ESL 2 receives the data packet from the access point 605, the connection between the access point 605 and the ESL 2 is established. After the access point 605 receives the AUX_CONNECT RSP 670d from ESL 3, the access point 605 can transmit a data packet to ESL 3 to establish a connection with ESL 3. After the ESL 3 receives the data packet from the access point 605, the connection between the access point 605 and the ESL 3 is established.

For the lower portion 620 of FIG. 6, in the second subframe 630b of time, during operation, the access point 605 can transmit (e.g., broadcast) a PA 640b to the second set of ESLs (e.g., ESL 12 to ESL 22). The PA 640b can include a synchronization (sync) packet with eleven OpCodes, which are each associated with a respect ESL of the second set of eleven ESLs. The eleven OpCodes may specify a time slot for their associated ESL to transmit a response (e.g., an ERP) to the access point 605. After the ESLs (e.g., ESL 12 to ESL 22) receive the PA 640b from the access point 605, the ESLs (e.g., ESL 12 to ESL 22) can transmit (in response to receiving the PA 640b) ERPs 650c in their respective time slots. Then, the access point 605 may receive the ERPs 650c in those time slots.

In one or more aspects, the channel index of the VSOpCode can be used for a multi-access point use case. For example, for a multi-access point use case, a management entity (e.g., management entity 130 of FIG. 1) can coordinate with two access points (e.g., AP1 and AP2) for an ESL (e.g., ESL 1) associated with one access point (e.g., AP1) to establish a connection with another access point (e.g., AP2). For this case, the access point (e.g., AP1, such as AP 605) can transmit (e.g., broadcast) a periodic advertisement with the VSOpCode (e.g., PA+NewOpcode 690) to the set of ESLs (e.g., ESL 1 to ESL 11) of a subframe (e.g., subframe 630a). The VSOpCode can contain the Eid for ESL 1, the channel index for the other access point (e.g., AP2), and a time offset for ESL 1 to listen at a specific future time for an auxiliary connection request (AUX_CONNECT_REQ) transmitted from the other access point (e.g., AP2).

After ESL 1 receives the periodic advertisement with the VSOpCode (e.g., PA+NewOpcode 690), ESL 1 can adjust (tune) to the HFS associated with the channel index for the other access point (e.g., AP2) as indicated in the VSOpCode, and ESL 1 can listen at the specified future time for the auxiliary connection request (AUX_CONNECT_REQ) from the other access point (e.g., AP2). At the specified future time, the other access point (e.g., AP2) can transmit the auxiliary connection request (AUX_CONNECT_REQ) to the ESLs (e.g., ESL 1 to ESL 11).

After the ESLs (e.g., ESL 1 to ESL 11) receive the AUX_CONNECT_REQ from the other access point (e.g., AP2), the ESL (e.g., ESL 1) addressed in the AUX_CONNECT_REQ can transmit an auxiliary connection response (AUX_CONNECT_RSP) to the other access point (e.g., AP2) to acknowledge the receipt of the connection request. The other access point (e.g. AP2) can then receive the AUX CONNECT RSP. After the other access point (e.g., AP2) receives the AUX CONNECT RSP from the ESL (e.g., ESL 1), the other access point (e.g., AP2) can transmit a data packet to the ESL (e.g., ESL 1) to establish a connection with the ESL (e.g., ESL 1). After the ESL (e.g., ESL 1) receives the data packet from the other access point (e.g., AP2), the connection between the other access point (e.g., AP2) and the ESL (e.g., ESL 1) is established.

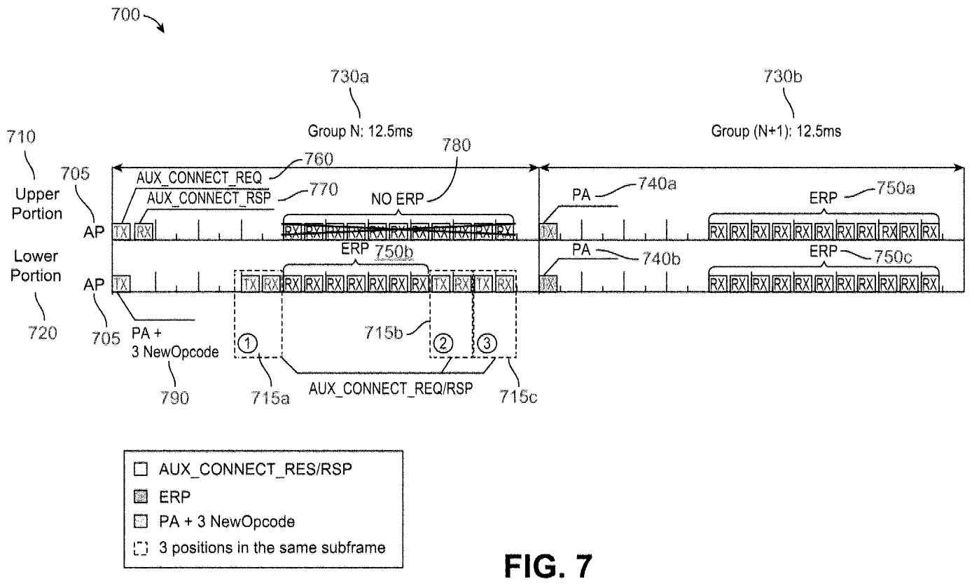

FIG. 7 shows another example of connection transmissions 700 that include the transmission of a periodic advertisement with the VSOpCode (e.g., PA+NewOpCode 790). In particular, FIG. 7 is a diagram illustrating an example of concurrency of fast connections 715a, 715b, 715c with a periodic advertisement with the VSOpCode (e.g., PA+NewOpCode 790), where connection transmissions 700 for fast connections 715a, 715b, 715c are transmitted within wireless communication device (e.g., ESL) response slots (e.g., a periodic advertisement response period, such as ERP 750b response slots) within a single subframe (e.g., a period of time, such as subframe 730a) of time. The fast connections 715a, 715b, 715c may include the transmission by an access point 705 (e.g., a network device, such as access point 110 of FIG. 1) of an auxiliary connection requests (AUX_CONNECT_REQ) to ESLs (e.g., wireless communication devices), and the receiving by that access point 605 of auxiliary connection responses (AUX_CONNECT_RSP) from the ESLs.

In one or more examples, a pair of an AUX_CONNECT_REQ and AUX CONNECT RSP of a fast connection can occupy two ERP response slots (e.g., ERPs 750b). As such, ideally, up two five pairs (e.g., if there are 11 ERP response slots) can be triggered at the same time by a single periodic advertisement. The remaining ERP response slots can continue to be used for response as directed by the normal OpCode. In some examples, up to three BLE connections can occur in parallel in a single subframe of time. As such, up to three BLE connections may be triggered by a single periodic advertisement for the same subframe. Each VSOpCode can manage one ESL to listen for the AUX CONNECT_REQ in one subsequent ERP slot.

In FIG. 7, two subframes 730a, 730b of time of a frame of time are shown. For each subframe 730a, 730b of time, the access point 705 can transmit communication transmissions (e.g., periodic advertisements and auxiliary connection requests) to a respective set of eleven ESLs. For subframe 730a of time, the access point 705 may transmit communications transmissions to a first set of ESLs (e.g., ESL1 to ESL 11 of a group of up to 255 ESLs); and for subframe 730b of time, the access point 705 may transmit communication transmissions to a second set of ESLs (e.g., ESL 12 to ESL 22 of the group of up to 255 ESLs). Each of the subframes 730a, 730b of time may have duration of time of 12.5 milliseconds.

In FIG. 7, the upper portion 710 of the figure shows the transmission of an auxiliary connection request instead of a periodic advertisement (e.g., which can have negative side effects), and the lower portion 720 of the figure shows the transmission of a periodic advertisement with the VSOpCode for fast connections. In the upper portion 710 of FIG. 7, in the first subframe 730a of time, during operation, the access point 705 may transmit (e.g., broadcast) an auxiliary connection request (AUX_CONNECT_REQ) 760, instead of a periodic advertisement, to the first set of ESLs (e.g., ESL 1 to ESL 11). The AUX CONNECT_REQ 760 is a request from the access point 705 to a specific ESL (e.g., ESL 1) of the first set of ESLs (e.g., ESL 1 to ESL 11) to connect with the access point 705. After the ESLs (e.g., ESL 1 to ESL 11) receive the AUX_CONNECT REQ 760 from the access point 705, the ESL (e.g., ESL 1) addressed in the AUX CONNECT REQ 760 can transmit an auxiliary connection response (AUX_CONNECT_RSP) 770 to the access point 705 to acknowledge the receipt of the connection request. The access point 705 may then receive the AUX CONNECT RSP 770 from the ESL (e.g., ESL 1). After the access point 705 receives the AUX CONNECT RSP 770 from the ESL (e.g., ESL 1), the access point 705 may transmit a data packet to the ESL (e.g., ESL 1) to establish a connection with the ESL (e.g., ESL 1). After the ESL (e.g., ESL 1) receives the data packet from the access point 705, the connection between the access point 705 and the ESL (e.g., ESL 1) can be established.

Since the access point 705 has transmitted (e.g., broadcasted) an auxiliary connection request (AUX_CONNECT_REQ) 760, instead of a periodic advertisement, to the first set of ESLs (e.g., ESL 1 to ESL 11), the access point 705 will not receive any ERPs 780 because the ESLs (e.g., ESL 1 to ESL 11) will not receive a periodic advertisement (e.g., PA) and, as such, the ESLs (e.g., ESL 1 to ESL 11) may not transmit ERPs 780, which are transmitted to acknowledge receipt of a periodic advertisement.

In the upper portion 710 of FIG. 7, in the second subframe 730b of time, during operation, the access point 705 can transmit (e.g., broadcast) a PA 740a to the second set of ESLs (e.g., ESL 12 to ESL 22). The PA 740a may include a synchronization (sync) packet with eleven OpCodes. Each of the eleven OpCodes may be associated with a respect ESL of the second set of eleven ESLs. The eleven OpCodes may specify a time slot for their associated ESL to transmit a response (e.g., an ERP) to the access point 705. After the ESLs (e.g., ESL 12 to ESL 22) receive the PA 740a from the access point 705, the ESLs (e.g., ESL 12 to ESL 22) can transmit (in response to receiving the PA 740a) ERPs 750a in their respective time slots. Then, the access point 705 can receive the ERPs 750a in those time slots.

In the lower portion 720 of FIG. 7, in the first subframe 730a of time, during operation, the access point 705 may transmit (e.g., broadcast) a periodic advertisement with the VSOpCode (e.g., PA+NewOpCode 790) to the first set of ESLs (e.g., ESL 1 to ESL 11). The VSOpCode can include at least one ESL identification (Eid) (e.g., the identification of an ESL within the subframe of time that the access point wants to connect with), at least one channel index (e.g., the channel index for the hopping frequency sequence (HFS) of the access point for an ESL to connect with), and at least one time offset (e.g., which specifies a specific future time for an ESL to listen for an auxiliary connection request).

For this example, the VSOpCode can include the Eids for ESL 1, ESL 2, and ESL 3; a channel index for the access point 605; and time offsets for ESL 1, ESL 2, and ESL 3. For this example, the time offsets for ESL 1 may specify that ESL 1 should listen for the AUX CONNECT_REQ in time slots that are located just prior to the beginning of the ERP 750b response slots of the first subframe 730a of time; and the time offsets for ESL 2 and ESL 3 may specify that ESL 2 and ESL 3 should listen for the AUX CONNECT_REQ from the access point 705 in specific time slots that are within the ERP 750b response slots of the first subframe 730a of time.

After the ESLs (e.g., ESL 3 to ESL 11) receive the periodic advertisement with the VSOpCode (e.g., PA+NewOpCode 790) from the access point 705, the ESLs (e.g., ESL 3 to ESL 11) may transmit (in response to receiving the PA+NewOpCode 790) ERPs 750b in their respective time slots. Then, the access point 705 can receive the ERPs 750b in those time slots.

After ESL 1, ESL 2, and ESL 3 receive the periodic advertisement with the VSOpCode (e.g., PA+NewOpcode 790), ESL 1, ESL 2, and ESL 3 can confirm that they are tuned to the HFS associated with the channel index for the access point 705 as indicated in the VSOpCode. ESL 1 can listen at the specified future time for the AUX CONNECT_REQ from the access point 705 (e.g., for fast connection 715a), ESL 2 can listen at the specified future time for the AUX_CONNECT_REQ from the access point 705 (e.g., for fast connection 715b), and ESL 3 can listen at the specified future time for the AUX CONNECT_REQ from the access point 705 (e.g., for fast connection 715c).

After ESL 1 has received the AUX CONNECT_REQ (e.g., for fast connection 715a), ESL 1 can transmit an AUX_CONNECT_RSP to acknowledge receipt of the connection request. After ESL 2 has received the AUX_CONNECT_REQ (e.g., for fast connection 715b), ESL 2 can transmit an AUX_CONNECT_RSP to acknowledge receipt of the connection request. Similarly, after ESL 3 has received the AUX CONNECT_REQ (e.g., for fast connection 715c), ESL 3 can transmit an AUX CONNECT_RSP to acknowledge receipt of the connection request.

After the access point 705 receives the AUX CONNECT RSP from ESL 1, the access point 705 can transmit a data packet to ESL 1 to establish a connection with ESL 1. After the ESL 1 receives the data packet from the access point 705, the connection between the access point 705 and the ESL 1 can be established. After the access point 705 receives the AUX_CONNECT_RSP from ESL 2, the access point 705 can transmit a data packet to ESL 2 to establish a connection with ESL 2. After the ESL 2 receives the data packet from the access point 705, the connection between the access point 705 and the ESL 2 can be established. After the access point 705 receives the AUX CONNECT RSP from ESL 3, the access point 705 can transmit a data packet to ESL 3 to establish a connection with ESL 3. After the ESL 3 receives the data packet from the access point 705, the connection between the access point 705 and the ESL 3 can be established.

In the lower portion 720 of FIG. 7, in the second subframe 730b of time, during operation, the access point 705 can transmit (e.g., broadcast) a PA 740b to the second set of ESLs (e.g., ESL 12 to ESL 22). The PA 740b may include a synchronization (sync) packet with eleven OpCodes, which may be each associated with a respect ESL of the second set of eleven ESLs. The eleven OpCodes can specify a time slot for their associated ESL to transmit a response (e.g., an ERP) to the access point 705. After the ESLs (e.g., ESL 12 to ESL 22) receive the PA 740b from the access point 705, the ESLs (e.g., ESL 12 to ESL 22) can transmit (in response to receiving the PA 740b) ERPs 750c in their respective time slots. The access point 705 may then receive the ERPs 750c in those time slots.

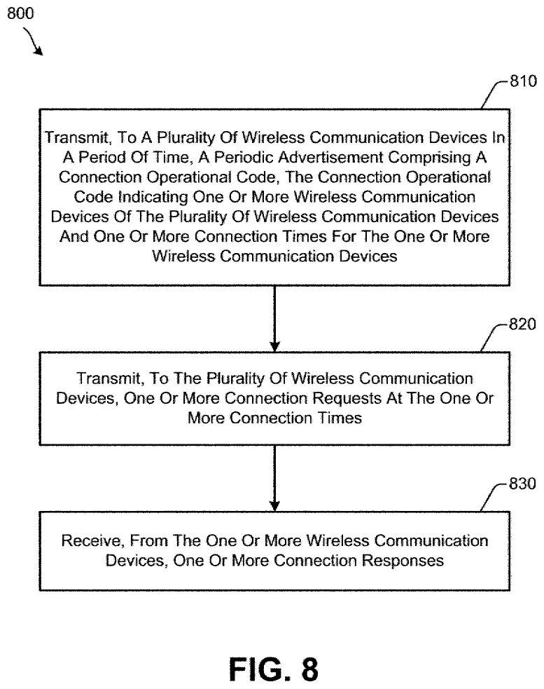

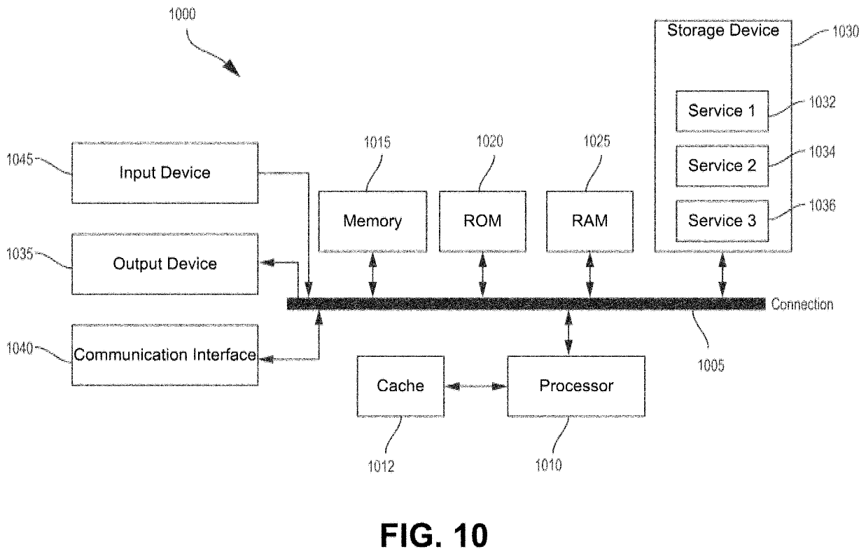

FIG. 8 is a flow chart illustrating an example of a process 800 for wireless communications utilizing methods for concurrency of a fast connection and PA. The process 800 can be performed by a network device (e.g., access point 110 of FIG. 1) or by a component or system (e.g., a chipset) of the network device. The operations of the process 800 may be implemented as software components that are executed and run on one or more processors (e.g., the processor 210 of FIG. 2, the processor 1010 of FIG. 10, and/or other processor(s)). Further, the transmission and reception of signals by the network device in the process 800 may be enabled, for example, by one or more antennas and/or one or more transceivers such as one or more wireless transceivers (e.g., the communication component 235 of FIG. 2, the communication interface 1040 of FIG. 10, and/or other antenna(s) and/or transceiver(s)).

At block 810, the network device (or component thereof) can transmit (e.g., using the communication component 235 of FIG. 2, the communication interface 1040 of FIG. 10, and/or other antenna(s) and/or transceiver(s)), to a plurality of wireless communication devices in a period of time, a periodic advertisement including a connection operational code. The period of time can include a subframe (e.g., subframe 630a or 630b of FIG. 6, subframe 730 or 730b of FIG. 7, etc.) of a frame that includes a plurality of subframes. In some cases, each wireless communication device of the plurality of wireless communication devices is an electronic shelf label (ESL).

The connection operational code indicates one or more wireless communication devices of the plurality of wireless communication devices and one or more connection times for the one or more wireless communication devices. In some aspects, the connection operational code includes an identification of the one or more wireless communication devices (which provides the indication of the one or more wireless communication devices). For example, the connection operational code can include a respective ESL identification (Eid) (e.g., the identification of an ESL within the subframe that the access point wants to connect with) for each wireless communication device of the one or more wireless communication devices. The connection operational code can additionally or alternatively include a channel index for the network device (e.g., the channel index for the hopping frequency sequence (HFS) of the network device for a wireless communication device to connect with) and/or a channel index for one or more other network devices. The connection operational code can additionally or alternatively include one or more time offsets for the one or more connection times. For example, a time offset can specify a specific future time for an ESL to listen for an auxiliary connection request. In one illustrative example, the connection operational code is a vendor specific operational code (e.g., VSOpCode).

In some cases, such as described with respect to FIG. 6 and FIG. 7, at least one of the connection times of the one or more connection times is within the period of time, within a period of time subsequent to the period of time, and/or within a periodic advertisement (PA) response period.

At block 820, the network device (or component thereof) can transmit (e.g., using the communication component 235 of FIG. 2, the communication interface 1040 of FIG. 10, and/or other antenna(s) and/or transceiver(s)), to the plurality of wireless communication devices, one or more connection requests at the one or more connection times. In one illustrative example, each connection request of the one or more connection requests is an auxiliary connection request (e.g., AUX_CONNECT_REQ), such as shown in FIG. 6 and FIG. 7.

At block 830, the network device (or component thereof) can receive (e.g., using the communication component 235 of FIG. 2, the communication interface 1040 of FIG. 10, and/or other antenna(s) and/or transceiver(s)), from the one or more wireless communication devices, one or more connection responses. In one illustrative example, each connection response of the one or more connection responses is an auxiliary connection response (e.g., AUX_CONNECT_RSP), such as shown in FIG. 6 and FIG. 7.

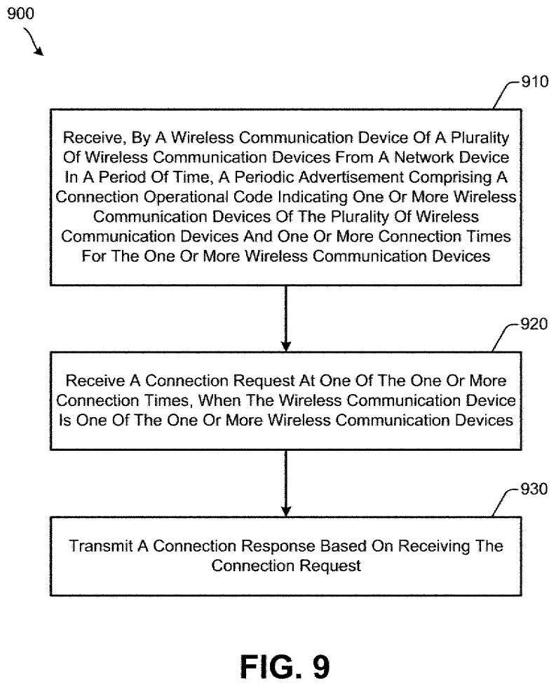

FIG. 9 is a flow chart illustrating an example of a process 900 for wireless communications utilizing methods for concurrency of a fast connection and PA. The process 900 can be performed by a wireless communication device (e.g., wireless communication device 120 of FIG. 1, which may be in the form of an ESL) or by a component or system (e.g., a chipset) of the wireless communication device. The wireless communication device can be one of a plurality of wireless communication devices. The operations of the process 900 may be implemented as software components that are executed and run on one or more processors (e.g., the processor 210 of FIG. 2, the processor 1010 of FIG. 10, and/or other processor(s)). Further, the transmission and reception of signals by the wireless communications device in the process 900 may be enabled, for example, by one or more antennas and/or one or more transceivers such as one or more wireless transceivers (e.g., the communication component 235 of FIG. 2, the communication interface 1040 of FIG. 10, and/or other antenna(s) and/or transceiver(s)).

At block 910, the wireless communication device (or component thereof) can receive (e.g., using the communication component 235 of FIG. 2, the communication interface 1040 of FIG. 10, and/or other antenna(s) and/or transceiver(s)), from a network device in a period of time, a periodic advertisement including a connection operational code. The period of time can include a subframe (e.g., subframe 630a or 630b of FIG. 6, subframe 730 or 730b of FIG. 7, etc.) of a frame that includes a plurality of subframes. In some aspects, the network device is an access point.

The connection operational code indicates one or more wireless communication devices (which may include the wireless communication device) of the plurality of wireless communication devices and one or more connection times for the one or more wireless communication devices. In some aspects, the connection operational code includes an identification of the one or more wireless communication devices (which provides the indication of the one or more wireless communication devices). For example, the connection operational code can include a respective ESL identification (Eid) (e.g., the identification of an ESL within the subframe that the access point wants to connect with) for each wireless communication device of the one or more wireless communication devices. The connection operational code can additionally or alternatively include a channel index for the network device (e.g., the channel index for the hopping frequency sequence (HFS) of the network device for a wireless communication device to connect with) and/or a channel index for one or more other network devices. The connection operational code can additionally or alternatively include one or more time offsets for the one or more connection times. For example, a time offset can specify a specific future time for an ESL to listen for an auxiliary connection request. In one illustrative example, the connection operational code is a vendor specific operational code (e.g., VSOpCode).

In some cases, such as described with respect to FIG. 6 and FIG. 7, at least one of the connection times of the one or more connection times is within the period of time, within a period of time subsequent to the period of time, and/or within a periodic advertisement (PA) response period.

At block 920, the wireless communication device (or component thereof) can receive (e.g., using the communication component 235 of FIG. 2, the communication interface 1040 of FIG. 10, and/or other antenna(s) and/or transceiver(s)) a connection request at one of the one or more connection times. In one illustrative example, the connection request is an auxiliary connection request (e.g., AUX_CONNECT_REQ), such as shown in FIG. 6 and FIG. 7.

At block 930, the wireless communication device (or component thereof) can transmit (e.g., using the communication component 235 of FIG. 2, the communication interface 1040 of FIG. 10, and/or other antenna(s) and/or transceiver(s)) a connection response based on receiving the connection request. In one illustrative example, the connection response is an auxiliary connection response (e.g., AUX_CONNECT_RSP), such as shown in FIG. 6 and FIG. 7.

The network device and/or the wireless communication device may include various components, such as one or more input devices, one or more output devices, one or more processors, one or more microprocessors, one or more microcomputers, one or more cameras, one or more sensors, one or more receivers, transmitters, and/or transceivers, and/or other component(s) that are configured to carry out the steps of processes described herein. In some examples, the computing device may include a display, a network interface configured to communicate and/or receive the data, any combination thereof, and/or other component(s). The network interface may be configured to communicate and/or receive Internet Protocol (IP) based data or other type of data.

The components of the network device configured to perform the process 800 of FIG. 8 and/or the components of the wireless communication device configured to perform the process 900 of FIG. 9 can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

The process 800 and the process 900 are illustrated as logical flow diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the process 800, the process 900, and/or any other process described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program including a plurality of instructions executable by one or more processors. The computer-readable or machine-readable storage medium may be non-transitory.

FIG. 10 is a block diagram illustrating an example of a computing system 1000, which may be employed by the disclosed systems and techniques for concurrency of a fast connection and PA. In particular, FIG. 10 illustrates an example of computing system 1000, which can be, for example, any computing device making up internal computing system, a remote computing system, a camera, or any component thereof in which the components of the system are in communication with each other using connection 1005. Connection 1005 can be a physical connection using a bus, or a direct connection into processor 1010, such as in a chipset architecture. Connection 1005 can also be a virtual connection, networked connection, or logical connection.

In some aspects, computing system 1000 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example system 1000 includes at least one processing unit (CPU or processor) 1010 and connection 1005 that communicatively couples various system components including system memory 1015, such as read-only memory (ROM) 1020 and random access memory (RAM) 1025 to processor 1010. Computing system 1000 can include a cache 1012 of high-speed memory connected directly with, in close proximity to, or integrated as part of processor 1010.

Processor 1010 can include any general purpose processor and a hardware service or software service, such as services 1032, 1034, and 1036 stored in storage device 1030, configured to control processor 1010 as well as a special-purpose processor where software instructions are incorporated into the actual processor design. Processor 1010 may essentially be a completely self-contained computing system, containing multiple cores or processors, a bus, memory controller, cache, etc. A multi-core processor may be symmetric or asymmetric.

To enable user interaction, computing system 1000 includes an input device 1045, which can represent any number of input mechanisms, such as a microphone for speech, a touch-sensitive screen for gesture or graphical input, keyboard, mouse, motion input, speech, etc. Computing system 1000 can also include output device 1035, which can be one or more of a number of output mechanisms. In some instances, multimodal systems can enable a user to provide multiple types of input/output to communicate with computing system 1000.

Computing system 1000 can include communications interface 1040, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

The communications interface 1040 may also include one or more range sensors (e.g., LIDAR sensors, laser range finders, RF radars, ultrasonic sensors, and infrared (IR) sensors) configured to collect data and provide measurements to processor 1010, whereby processor 1010 can be configured to perform determinations and calculations needed to obtain various measurements for the one or more range sensors. In some examples, the measurements can include time of flight, wavelengths, azimuth angle, elevation angle, range, linear velocity and/or angular velocity, or any combination thereof. The communications interface 1040 may also include one or more Global Navigation Satellite System (GNSS) receivers or transceivers that are used to determine a location of the computing system 1000 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1030 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 1030 can include software services, servers, services, etc., that when the code that defines such software is executed by the processor 1010, it causes the system to perform a function. In some aspects, a hardware service that performs a particular function can include the software component stored in a computer-readable medium in connection with the necessary hardware components, such as processor 1010, connection 1005, output device 1035, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories can include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of”′ a set and/or “one or more” of a set does not limit the set to the items listed in the set. For example, claim language reciting “at least one of A and B” or “at least one of A or B” can mean A, B, or A and B, and can additionally include items not listed in the set of A and B.

Illustrative aspects of the disclosure include:
Aspect 1. A network device for wireless communication, the network device comprising: at least one memory; and at least one processor coupled to the at least one memory and configured to: transmit, to a plurality of wireless communication devices in a period of time, a periodic advertisement comprising a connection operational code, the connection operational code indicating one or more wireless communication devices of the plurality of wireless communication devices and one or more connection times for the one or more wireless communication devices; transmit, to the plurality of wireless communication devices, one or more connection requests at the one or more connection times; and receive, from the one or more wireless communication devices, one or more connection responses.
Aspect 2. The network device of Aspect 1, wherein the network device is an access point.
Aspect 3. The network device of any one of Aspects 1 or 2, wherein each wireless communication device of the plurality of wireless communication devices is an electronic shelf label.
Aspect 4. The network device of any one of Aspects 1 to 3, wherein the connection operational code comprises an identification of the one or more wireless communication devices, at least one of a channel index for the network device or a channel index for one or more other network devices, and one or more time offsets for the one or more connection times.
Aspect 5. The network device of any one of Aspects 1 to 4, wherein at least one connection time of the one or more connection times is within the period of time.
Aspect 6. The network device of any one of Aspects 1 to 5, wherein at least one connection time of the one or more connection times is within a period of time subsequent to the period of time.
Aspect 7. The network device of any one of Aspects 1 to 6, wherein at least one connection time of the one or more connection times is within a periodic advertisement response period.
Aspect 8. The network device of any one of Aspects 1 to 7, wherein the period of time is a subframe of a frame, and wherein the frame includes a plurality of subframes.
Aspect 9. The network device of any one of Aspects 1 to 8, wherein each connection request of the one or more connection requests is an auxiliary connection request.
Aspect 10. The network device of any one of Aspects 1 to 9, wherein each connection response of the one or more connection responses is an auxiliary connection response.
Aspect 11. The network device of any one of Aspects 1 to 10, wherein the connection operational code is a vendor specific operational code.
Aspect 12. A method of wireless communication performed at a network device, the method comprising: transmitting, by the network device to a plurality of wireless communication devices in a period of time, a periodic advertisement comprising a connection operational code, the connection operational code indicating one or more wireless communication devices of the plurality of wireless communication devices and one or more connection times for the one or more wireless communication devices; transmitting, by the network device to the plurality of wireless communication devices, one or more connection requests at the one or more connection times; and receiving, by the network device from the one or more wireless communication devices, one or more connection responses.
Aspect 13. The method of Aspect 12, wherein the network device is an access point.
Aspect 14. The method of any one of Aspects 12 or 13, wherein each wireless communication device of the plurality of wireless communication devices is an electronic shelf label.
Aspect 15. The method of any one of Aspects 12 to 14, wherein the connection operational code comprises an identification of the one or more wireless communication devices, at least one of a channel index for the network device or a channel index for one or more other network devices, and one or more time offsets for the one or more connection times.
Aspect 16. The method of any one of Aspects 12 to 15, wherein at least one connection time of the one or more connection times is within the period of time.
Aspect 17. The method of any one of Aspects 12 to 16, wherein at least one connection time of the one or more connection times is within a period of time subsequent to the period of time.
Aspect 18. The method of any one of Aspects 12 to 17, wherein at least one connection time of the one or more connection times is within a periodic advertisement response period.
Aspect 19. The method of any one of Aspects 12 to 18, wherein the period of time is a subframe of a frame, and wherein the frame includes a plurality of subframes.
Aspect 20. The method of any one of Aspects 12 to 19, wherein each connection request of the one or more connection requests is an auxiliary connection request.
Aspect 21. The method of any one of Aspects 12 to 20, wherein each connection response of the one or more connection responses is an auxiliary connection response.
Aspect 22. The method of any one of Aspects 12 to 21, wherein the connection operational code is a vendor specific operational code.
Aspect 23. A wireless communication device for wireless communication, the wireless communication device comprising: at least one memory; and at least one processor coupled to the at least one memory and configured to: receive, from a network device in a period of time, a periodic advertisement comprising a connection operational code, the connection operational code indicating one or more wireless communication devices of a plurality of wireless communication devices and one or more connection times for the one or more wireless communication devices; receive a connection request at one of the one or more connection times, wherein the wireless communication device is one of the one or more wireless communication devices; and transmit a connection response based on receiving the connection request.
Aspect 24. The wireless communication device of Aspect 23, wherein the network device is an access point.
Aspect 25. The wireless communication device of any one of Aspects 23 or 24, wherein each wireless communication device of the plurality of wireless communication devices is an electronic shelf label.
Aspect 26. The wireless communication device of any one of Aspects 23 to 25, wherein the connection operational code comprises an identification of the one or more wireless communication devices, at least one of a channel index for the network device or a channel index for one or more other network devices, and one or more time offsets for the one or more connection times.
Aspect 27. The wireless communication device of any one of Aspects 23 to 26, wherein at least one connection time of the one or more connection times is within the period of time.
Aspect 28. The wireless communication device of any one of Aspects 23 to 27, wherein at least one connection time of the one or more connection times is within a period of time subsequent to the period of time.
Aspect 29. The wireless communication device of any one of Aspects 23 to 28, wherein at least one connection time of the one or more connection times is within a periodic advertisement response period.
Aspect 30. The wireless communication device of any one of Aspects 23 to 29, wherein the period of time is a subframe of a frame, and wherein the frame includes a plurality of subframes.
Aspect 31. The wireless communication device of any one of Aspects 23 to 30, wherein the connection request is an auxiliary connection request.
Aspect 32. The wireless communication device of any one of Aspects 23 to 31, wherein the connection response is an auxiliary connection response.
Aspect 33. The wireless communication device of any one of Aspects 23 to 32, wherein the connection operational code is a vendor specific operational code.
Aspect 34. A method of wireless communication performed at a wireless communication device, the method comprising: receiving, by the wireless communication device of a plurality of wireless communication devices from a network device in a period of time, a periodic advertisement comprising a connection operational code, the connection operational code indicating one or more wireless communication devices of the plurality of wireless communication devices and one or more connection times for the one or more wireless communication devices; receiving, by the wireless communication device, a connection request at one of the one or more connection times, wherein the wireless communication device is one of the one or more wireless communication devices; and transmitting, by the wireless communication device, a connection response based on receiving the connection request.
Aspect 35. The method of Aspect 34, wherein the wireless communication device is an electronic shelf label.
Aspect 36. The method of any one of Aspects 34 or 35, wherein the network device is an access point.
Aspect 37. The method of any one of Aspects 34 to 36, wherein the connection operational code comprises an identification of the one or more wireless communication devices, at least one of a channel index for the network device or a channel index for one or more other network devices, and one or more time offsets for the one or more connection times.
Aspect 38. The method of any one of Aspects 34 to 37, wherein at least one connection time of the one or more connection times is within the period of time.
Aspect 39. The method of any one of Aspects 34 to 38, wherein at least one connection time of the one or more connection times is within a period of time subsequent to the period of time.
Aspect 40. The method of any one of Aspects 34 to 39, wherein at least one connection time of the one or more connection times is within a periodic advertisement response period.
Aspect 41. The method of any one of Aspects 34 to 40, wherein the period of time is a subframe of a frame, and wherein the frame includes a plurality of subframes.
Aspect 42. The method of any one of Aspects 34 to 41, wherein the connection request is an auxiliary connection request.
Aspect 43. The method of any one of Aspects 34 to 42, wherein the connection response is an auxiliary connection response.
Aspect 44. The method of any one of Aspects 34 to 43, wherein the connection operational code is a vendor specific operational code.
Aspect 45. A non-transitory computer-readable medium having stored thereon instructions that, when executed by at least one processor, cause the at least one processor to perform operation according to any of Aspects 12 to 22.
Aspect 46. An apparatus for wireless communications, comprising one or more means for performing operations according to any of Aspects 12 to 22.
Aspect 47. A non-transitory computer-readable medium having stored thereon instructions that, when executed by at least one processor, cause the at least one processor to perform operation according to any of Aspects 34 to 44.
Aspect 48. An apparatus for wireless communications, comprising one or more means for performing operations according to any of Aspects 34 to 44.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.”

1. A network device for wireless communication, the network device comprising:
at least one memory; and
at least one processor coupled to the at least one memory and configured to:
transmit, to a plurality of wireless communication devices in a period of time, a periodic advertisement comprising a connection operational code, the connection operational code indicating one or more wireless communication devices of the plurality of wireless communication devices and one or more connection times for the one or more wireless communication devices;
transmit, to the plurality of wireless communication devices, one or more connection requests at the one or more connection times; and
receive, from the one or more wireless communication devices, one or more connection responses.

2. The network device of claim 1, wherein the network device is an access point.

3. The network device of claim 1, wherein each wireless communication device of the plurality of wireless communication devices is an electronic shelf label.

4. The network device of claim 1, wherein the connection operational code comprises an identification of the one or more wireless communication devices, at least one of a channel index for the network device or a channel index for one or more other network devices, and one or more time offsets for the one or more connection times.

5. The network device of claim 1, wherein at least one connection time of the one or more connection times is within the period of time.

6. The network device of claim 1, wherein at least one connection time of the one or more connection times is within a period of time subsequent to the period of time.

7. The network device of claim 1, wherein at least one connection time of the one or more connection times is within a periodic advertisement response period.

8. The network device of claim 1, wherein the period of time is a subframe of a frame, and wherein the frame includes a plurality of subframes.

9. The network device of claim 1, wherein each connection request of the one or more connection requests is an auxiliary connection request.

10. The network device of claim 1, wherein each connection response of the one or more connection responses is an auxiliary connection response.

11. The network device of claim 1, wherein the connection operational code is a vendor specific operational code.

12. A wireless communication device for wireless communication, the wireless communication device comprising:
at least one memory; and
at least one processor coupled to the at least one memory and configured to:
receive, from a network device in a period of time, a periodic advertisement comprising a connection operational code, the connection operational code indicating one or more wireless communication devices of a plurality of wireless communication devices and one or more connection times for the one or more wireless communication devices;
receive a connection request at one of the one or more connection times, wherein the wireless communication device is one of the one or more wireless communication devices; and transmit a connection response based on receiving the connection request.

13. The wireless communication device of claim 12, wherein the network device is an access point.

14. The wireless communication device of claim 12, wherein each wireless communication device of the plurality of wireless communication devices is an electronic shelf label.

15. The wireless communication device of claim 12, wherein the connection operational code comprises an identification of the one or more wireless communication devices, at least one of a channel index for the network device or a channel index for one or more other network devices, and one or more time offsets for the one or more connection times.

16. The wireless communication device of claim 12, wherein at least one connection time of the one or more connection times is within the period of time.

17. The wireless communication device of claim 12, wherein at least one connection time of the one or more connection times is within a period of time subsequent to the period of time.

18. The wireless communication device of claim 12, wherein at least one connection time of the one or more connection times is within a periodic advertisement response period.

19. The wireless communication device of claim 12, wherein the period of time is a subframe of a frame, and wherein the frame includes a plurality of subframes.

20. The wireless communication device of claim 12, wherein the connection request is an auxiliary connection request.

21-30. (canceled)
